(19) United States
(12) Patent Application Publication
(10) Pub. No.: US 2023/0116160 A1
(43) Pub. Date: Apr. 13, 2023

(54) Carbon Nanotube Hybrid Material for Concrete Applications

(71) Applicant: Chasm Advanced Materials, Inc., Canton, MA (US)

(72) Inventors: Ricardo A. Prada Silvy, Norman, OK (US); David J. Arthur, Canton, MA (US); Harikuma K. Harikumar, Needhan, MA (US); Sathish Kumar Lageshetty, Edmond, OK (US)

(21) Appl. No.: 17/964,447

(22) Filed: Oct. 12, 2022

Related U.S. Application Data
(60) Provisional application No. 63/255,067, filed on Oct. 13, 2021.

(51) Int. Cl. C04B 14/02; C04B 28/04; C04B 28/02; C04B 20/00; C04B 40/00; C01B 32/162; C01B 32/168

(52) U.S. Cl. CPC C04B 14/026; C04B 28/04; C04B 28/021; C04B 20/0004; C04B 40/0042; C01B 32/162; C01B 32/168; C01P 2004/54

(57) ABSTRACT

A carbon nanotube (CNT) hybrid material that includes a blend comprising a catalyst supported on at least one of a metal, metalloid, metal oxide or carbon support, and at least one material selected from the group of materials consisting of: cementitious materials, materials used in the production of cementitious materials, and materials used to enhance cementitious materials, and CNT on the blend.

### CROSS-REFERENCE TO RELATED APPLICATION

This application claims priority to Provisional Application 63/255,067 filed on Oct. 13, 2021, the entire disclosure of which is incorporated by reference herein for all purposes.

### BACKGROUND

This disclosure relates to carbon nanotube hybrid materials.

The concrete industry, like the rest of the construction industry, is currently facing significant technological challenges due to environmental pressures, which require a strong reduction in the levels of CO₂ emissions generated during its production process, and economic pressure to improve the performance efficiency and durability of construction materials to produce much stronger, thinner and lighter structural components at lower cost. These technical, environmental and economic requirements will have a significant impact on its production cost and consequently, its price in the market. The world production of concrete in 2020 was approximately 4.1 billion tons and this contributed about 8.0% of global CO₂ emissions (which totaled about 36.4 billion metric tons) which takes into account the CO₂ emissions produced during the cement manufacturing process (1.56 billion metric tons), consumption of fuel and electricity (1.16 billion metric tons), and transportation (0.17 metric tons). Due to the accelerated economic and population growth in some areas of the world (e.g., Asia and the Middle East), it was forecast that the future concrete world production capacity will increase about 5 billion metric tons by 2030, with China being currently the main worldwide concrete producing country (about 53% of worldwide production).

Various strategies have been followed to improve the sustainability of concrete and even to develop green or ecological concrete. These strategies include: incorporating recycled materials and waste (industry, agriculture, domestic) in concrete, optimizing the mix design, reducing CO₂ emissions by decreasing Portland cement content, partially replacing Portland cement with cementitious materials and binders (e.g., nano alumina particles, fly ashes, silica fume, blast furnace slag), increasing the durability of concrete to extend its life by using reinforcing materials (e.g., carbon fibers (CFs), carbon nanotubes (CNTs), steel fibers), reducing long-term resources consumption, and select low impact construction methods. It has been observed that nano-Al₂O₃ particles can be effective to increase the modulus of elasticity of cement mortar. With 5 wt. % nano-Al₂O₃ (˜150 nm particle size), the elastic modulus increased by 143% at 28 curing days. During cement hydration, nano-alumina particles were available to fill the pores at the sand-paste interfaces creating a dense interfacial transition zone (ITZ) with less porosity. The effective densification of the ITZ is responsible for the significant increase of the elastic modulus of mortars.

Reinforcing the cementitious matrix with carbon nanomaterials can provide a viable alternative to achieve the above goals. Carbon nanotubes (CNTs) have attracted attention as a reinforcing material for the cementitious matrix due to their mechanical properties (Young's modulus of 1 TPa; tensile strength of individual tubes >60 GPa; and fracture deformation greater than 12%), low density, unique physical and chemical properties, thermal and electrical conductivity, and piezoelectric response. These properties have made CNTs a suitable candidate as reinforcement in cement-based smart materials.

The CNTs enhancement capability to the nanocomposites (i.e., CNTs reinforced cement-based materials) depends on many factors, among them the CNTs' intrinsic structure and surface properties, single-wall CNT (SWCNT), few-wall CNT (FWCNT) or multi-wall CNT (MWCNT), their final aspect ratio (e.g., whether the nanotubes were shortened as a result of disaggregate treatment), the quality of CNTs dispersion in the matrix, CNTs content level, composition and structure of matrix, and the interfacial bonding condition between CNTs and the matrix. Effects of MWCNTs length (short versus long), the fracture properties of the nanocomposites for a constant weight ratio of surfactant to MWCNTs, and the effect of the surfactant concentration on the fracture properties of the nanocomposites reinforced with 0.08 wt. % of long MWCNTs, have been studied. The fracture mechanics test results indicate that the flexural strength and the Young's modulus of the cement matrix significantly increase through use of small amounts of MWCNTs (0.048 wt. % and 0.08 wt. %) as compared to the same material without CNTs, and the nanocomposites exhibit an increase of the Young's modulus of at least 15% up to about 55% and an increase in flexural strength of at least of 8% up to about 40%. An over 45% increase in the 28-day flexural strength is realized at a 0.08 wt. % MWCNTs loading versus an un-modified control. In particular, higher concentrations of short MWCNTs are required to achieve effective reinforcement, while lower amounts of longer MWCNTs are needed to achieve the same level of mechanical performance.

Nanocomposites with different concentrations of MWCNTs and different concentrations and combinations of surfactants have also been studied. These studies have found that the fracture toughness and critical opening displacement of the nanocomposites with 0.5 wt. % of MWCNTs can be enhanced by 175% and 55%, relative to the plain cement paste, respectively. Also, researchers have prepared CNTs reinforced fly ash cement paste by adding CNTs at 0.5 and 1% by weight into a cement-fly ash (20% by weight of cement) system; it was found that the use of CNTs results in higher compressive strength of the nanocomposites. The highest strength obtained was found at 1 wt. % CNTs where the compressive strength at 28 days was 54.7 MPa (which is an increase of almost 100% in the relative strength as compared to that of Portland cement paste). With the use of 0.5% of carboxyl functionalized MWCNTs, enhancements of 149% and 35% in fracture toughness and critical opening displacement were realized as compared to the plain cement paste, respectively. Comparisons of the mechanical performances of carbon fiber (CFs) reinforced cement-based materials and CNTs reinforced cement-based materials, have established that the flexural and compressive strength of CNTs reinforced cement-based materials is 30% and 100% greater, respectively, than that of CFs reinforced cement-based materials (Table 1).

CNTs have been shown to have a thermal conductivity at least twice that of diamond. The negative coefficient of thermal expansion of the CNTs results in a higher thermal stability. Therefore, CNTs are expected to improve the thermal stability of cement-based materials. In a comparison of the thermal performance of CF reinforced cement-based materials and CNT reinforced cement-based materials, it was observed that the thermal conductivity of CNT reinforced cement-based materials is at least 35% and 85% greater than that of carbon fiber (CF) reinforced cement-based materials and unreinforced cement-based materials (typically 0.5-0.8 W/mK), respectively (Table 1).

TABLE 1
Comparison of mechanical and thermal conductivity properties
of CNTs and CFs reinforced cement-based materials.

| | Flexural | Compressive | Thermal |
|---|---|---|---|
| | strength | strength | conductivity |
| 7 days | (MPa) | (MPa) | (W/mk) @ 32.7° C. |
| CFs reinforced cement- | 2.42 | 14 | 1.1 |
| based materials | | | |
| CNTs reinforced cement- | 3.2 | 26.8 | 1.5 |
| based materials | | | |

Cement/CNT hybrids and fly ash/CNT hybrids have been prepared utilizing iron particles that are naturally present in the cement or fly ash as the CNT/CF catalyst. These hybrids have been used to fabricate CNT/CF reinforced cement paste. The materials reveal as much as two times increase in the compressive strength compared to plain cement paste. A 34% increase in the tensile strength has been realized by using cement/CNT hybrid containing 0.3 wt. % of CNTs.

Cement-based materials can have defects and microcracks in both the material and at the interfaces even before an external load is applied. These defects and microcracks emanate from excess water, bleeding, plastic settlement, thermal and shrinkage strains and stress concentrations imposed by external restraints. Under an applied load, distributed microcracks propagate, coalesce and align to produce macrocracks, sometimes leading to a precipitated catastrophic failure in the concrete structure. Under fatigue loads, cement-based materials crack easily, and cracks create easy access routes for deleterious agents.

There has been a great demand to monitor cracking structures and prevent cracks from propagating further and ensure the timely repair, safety and long-term durability of critical structures. Non-destructive evaluations, such as attaching or embedding foreign sensors (e.g., resistance strain gauges, optic sensors, piezoelectric ceramic, shape memory alloy and fiber reinforced polymer bars) onto or into structures, have been used in many ways to accommodate the demand, yet these sensors have some drawbacks including poor durability, low sensitivity, high cost, low survival rate and/or unfavorable compatibility with structures (i.e., loss of structural mechanical properties). It would be desired that the structural material itself has the sensing capability (i.e., structural materials are multifunctional or smart).

Self-detecting (piezoresistive) cement-based materials are reinforced by electrically conductive fillers to increase their ability to detect stress, strain, or cracks by themselves, while maintaining good mechanical properties. Electrically conductive fillers can be classified as fibrous and particulate fillers. Examples of suitable fibrous fillers include short carbon fibers (CFs), surface modification CFs, steel fibers, carbon-coated nylon fibers, etc., and those of effective particle fillers include carbon black, steel fiber, nickel powder, etc. As the piezoresistive cement-based materials are deformed or stressed, the contact state between the fillers and the matrix is changed, which affects the electrical resistance of the cement-based materials. Strain, stress, crack and damage can therefore be detected through measurement of the electrical resistance. Self-detecting cement-based materials not only have potential in the field of structural health monitoring and evaluation of the condition of concrete structures, but can also be used for road traffic control, border security, structural vibration control, etc. Electrified concrete with heating capabilities also enables more effective radiant floor heating and prevents icing of roadways and walkways.

Achieving dispersion of carbon nanotubes in construction materials in an effective commercially viable, practical, safe and economical way currently represents a great technological challenge. Carbon nanotubes tend to form bundles or ropes in aqueous and organic solution dispersions due to their high hydrophobic character, which means that the material cannot be efficiently dispersed and integrated into the cementitious matrix material. Cement consists of around 1-30 μm sized particles with broad size distribution. Some studies from the scientific literature have employed combinations of chemical and mechanical dispersion techniques of CNTs. Surfactant agents in combination with ultrasonication methods have been successfully employed to facilitate the dispersion of CNTs and water-reducing additives to modify the fluidity of the CNT-cement mixture. However, ultrasonication and high shear mixing techniques are not commercially scalable, and they can cause excessive damage to CNTs structure, reducing their efficiency in improving the mechanical strength, electrical and thermal conductivity properties and piezoelectric response. A high CNT aspect ratio is required to reach a percolation threshold at very low CNT loading in the concrete matrix. Handling CNTs powders may also represent potential health and safety risks. The cost of making CNTs is very high, and hence it is not realistic to apply them to cost-sensitive markets like construction. This also represents important limitations for the industrial use of CNTs in construction materials.

### PRIOR ART

CNT hybrid materials (CNT-Carbon, CNT-metals, and CNT-metallic oxides) represent today the third generation of carbon nanomaterials. A CNT/CF-cement hybrid material has been synthesized from Portland cement by growing the CNTs/CFs from Fe catalyst particles naturally occurring in cement (4 wt. % Fe₂O₃). The CNTs/CFs were grown using a modified Chemical Vapor Deposition (CVD) method, which included the addition of a screw feeder that continuously moved the cement through the reactor. This allowed continuous production of the CNT-cement hybrid material. Reaction temperature varied in the 500 to 700° C. range and an acetylene, CO and CO₂ gas mixture was used as the carbon source. Performance test results indicated that with the addition of 0.4 wt. % of the CNTs/CFs-cement hybrid material in the cement paste, the compressive strength and electrical conductivity increased by a factor of 2-3 and 40 times, respectively. However, this method of hybrid CNT-CFs-cement material synthesis, despite not requiring the CNT/CFs to be dispersed in the matrix, is impractical for at least the following reasons: 1) only the particles that contain iron oxide react to produce CNT and CF, 2) the CNT/CF have a low aspect ratio value (L/D<100), 3) the iron oxide content and its particle size vary in different types of cements therefore differences in carbon yield and morphological properties of CNTs/CFs occur, 4) the contact of the cement particles under high temperature reducing atmospheres during the hybrid material synthesis can also cause undesirable structural changes in the components of the cement particles, as well as the formation of other types of amorphous carbon compounds, and 5) the ethylene and carbon monoxide that do not react must be burned, which generates CO₂ emissions.

### SUMMARY

Aspects and examples are directed to a carbon nanotube (CNT) hybrid material that includes a blend comprising a catalyst supported on at least one of a metal, metalloid, metal oxide or carbon support, and at least one material selected from the group of materials consisting of: cementitious materials, materials used in the production of cementitious materials, and materials used to enhance cementitious materials, and CNT on the blend.

There is a need to develop a new generation of carbon nanomaterials that exhibit greater dispersion to assure a homogeneous distribution and that can be easily integrated into the cementitious matrix using conventional mixing equipment. These new carbon nanomaterials will preferably not require the use of surfactants or water reducing agents. This can be achieved if the material has an optimized hydrophilic/hydrophobic balance. In some examples the hydrophilic part of the material is alumina while the hydrophobic is CNT. This is the reason why this material disperses better than CNT alone. These new carbon nanomaterials should significantly increase one or more of the mechanical, electrical and thermal properties, and exhibit the piezoelectric response, of advanced construction materials. They must also be safe materials and of lower production cost.

In some examples this disclosure describes a carbon hybrid nanomaterial based on carbon nanotubes exhibiting a high aspect ratio (for example, LID>1000) and nano-alumina particles (for example, hundreds of nanometers particle sizes). In some examples these hybrid materials are used in advanced construction materials, including but not limited to cement, foam cement, and other compatible materials, and cementitious materials such as fly ash.

The CNT-alumina hybrid material is synthesized in some examples using a catalyst that combines transition metals supported on fine alumina particles (for example, sizes <70 microns). This alumina has a high specific surface (>300 m²/g). The active metal loading on the alumina support is less than 1% by weight, approximately 3-5 times less than in conventional catalysts used in the prior art for the synthesis of carbon nanotubes. This leads to the active metal being highly dispersed on the surface of the support, enabling the synthesis of long and straight CNT tubes (e.g., >10 microns), having a smaller diameter (e.g., <15 nm). This hybrid CNT-nano-alumina material shows a balanced hydrophobicity/hydrophilicity property, depending on the carbon composition in the material that varies between 5 and 70 wt. %. The aspect ratio of CNTs is also a function of carbon yield. Alumina particles can alternatively or additionally be added to the reactor along with the catalyst.

In some examples the synthesis of the hybrid material CNT-Al₂O₃ is carried out by the CCVD method, using a rotary tube catalytic reactor or a fluidized bed reactor at temperatures typically between 600 and 700° C. and at atmospheric pressure. An example of such a reactor system is illustrated in FIG. 1, described below. In some examples ethylene is used as the carbon source, but other types of carbon sources, such as methane, ethane, acetylene, and/or CO, can be used. The residence time of the material in the reaction zone typically varies between 5 and 20 minutes, depending on the desired carbon yield for the specific application.

The dispersion of CNT-Al₂O₃ hybrid in aqueous solution is very helpful for distributing the carbon nanomaterial in the cement matrix, which can be easily performed using known mixing methods for conventional cement-based materials. The hybrid material can be integrated with the cement particles using different techniques. For example, by mechanical mixing of powders, or by following two consecutive preparation steps: 1) preparing a suspension of CNT-Al₂O₃ hybrid in aqueous solution and 2) adding the suspension of CNT-Al₂O₃ hybrid to the cement matrix.

There are several differences between known hybrid CNT-cement materials and those of the present disclosure. In the prior art, the iron contained in the cement acts as a catalyst for the formation of CNT/CF. The content of iron in cement is variable, therefore a constant carbon yield cannot be obtained. Also, the low CNT aspect ratios (L/D<100) do not provide the benefits of a significant increase in the mechanical properties, electrical properties, and thermal conductivities of concrete. Further, contacting the concrete particles under highly reducing conditions at high reaction temperatures can result in structural modifications of the constituent elements of the cementitious material. Further, the known synthesis methods are not scalable to the degree needed for real-world concrete production.

The present CNT-Al₂O₃ hybrid materials provide competitive advantages over the prior art. These advantages include but are not limited to: 1) the material has high aspect ratio carbon nanotubes (in some examples at least about 1000) and alumina nanoparticles (100-800 nm sizes), which are additives used for the mechanical reinforcement of concrete, 2) its dispersion is easier than individual carbon nanotubes using industrial mixing techniques, 3) carbon nanotubes exhibit a narrow and uniform distribution of diameter, around 10+/−3 nm, which makes the material highly conductive, 4) the hybrid material is synthesized continuously using commercial rotary tube reactors, 5) the active metals content in the catalyst is less than 1 wt. %, which enables better control of the kinetics of growth of the tubes (straight and long tubes), 6) the material is safe and easy to use in practice and its production cost is low, 7) the material exhibits superior performance vs pristine CNTs in mechanical reinforcement, electrical conductivity and piezoelectric response when it was incorporated into the concrete, 8) tiny amounts of CNT-Al₂O₃ hybrid material enable the production of green and smart concrete, reducing the cement consumption by allowing the incorporation in concrete mixtures of greater amounts of others additives, such as fly ash. As a consequence of this, the lower cement consumption contributes to a reduction of CO₂ emissions which are responsible for global warming.

This disclosure contemplates catalyst supports other than alumina particles. Examples include but are not limited to other metal oxides, carbon materials, and potentially metalloids. Non-limiting examples of metal oxide supports include alumina, magnesia, and fly ash. Examples of carbon-based catalyst supports include graphite, graphene, carbon black, activated carbon, carbon nanofiber, vapor-grown carbon nanofiber, carbon fiber, carbon nanotubes, and the like. U.S. Patent Application Publication US2022/0048772A1 discloses carbon-CNT hybrid materials. U.S. Patent Application Publication US2022/0250912A1, discloses CNT hybrid materials that use metal and metal oxide supported catalysts. The disclosures of both of these prior applications and their publications are incorporated herein by reference, for all purposes.

This disclosure is not limited to compositions comprising supported catalyst particles blended with other particles that are considered cementitious' materials. The disclosure also includes compositions wherein the other particles may not be considered by some to be classified as cementitious materials, even if they may be one of the basic ingredients that are used in the production of ordinary Portland cement. For example, in some examples alumina comprises the “other” particles. Alumina may also or additionally be used as a catalyst support. Accordingly, this disclosure contemplates the other particles including cementitious materials as well as other ingredients that are used in the production of cementitious materials, or used to enhance cementitious materials, including but not limited to alumina. Also, the “other” particles can include other reinforcing materials that are or can be used in cement formulations, including but not limited to carbon nano fibers, carbon fibers, graphene, nano clays and the like.

All examples and features mentioned below can be combined in any technically possible way.

In one aspect a carbon nanotube (CNT) hybrid material includes a blend comprising a catalyst supported on at least one of a metal, metalloid, metal oxide or carbon support, and at least one cementitious material and/or material that is or can be used in the production of or enhancement of cement/cementitious materials, with CNT on the blend.

Some examples include one of the above and/or below features, or any combination thereof. In an example the cementitious material comprises a hydraulic cement. In an example the hydraulic cement comprises Portland cement. In an example the cementitious material comprises a supplementary cementitious material (SCM). In an example the SCM comprises fly ash. In an example the catalyst is supported on nano-alumina particles.

Some examples include one of the above and/or below features, or any combination thereof. In an example the CNT are grown on at least part of the blend in a rotary kiln reactor. In an example the supported catalyst and the cementitious or other material are blended and then fed into the reactor wherein CNT are grown on this blend. In an example the supported catalyst is fed into the reactor wherein CNT is grown on the supported catalyst to create a hybrid material, and then the hybrid material is blended with the cementitious or other material. In an example the hybrid material is blended with the cementitious or other material by mechanical mixing of the two in powder form. In an example the hybrid material is blended with the cementitious or other material by preparing a suspension of the hybrid material in an aqueous solution and then mixing the suspension with the cementitious or other material. In an example the material comprises a powder.

In another aspect a carbon nanotube (CNT) hybrid material includes a fly ash material comprising iron oxide and other metal oxides and CNTs on the fly ash. In an example the CNTs are grown on the fly ash in a rotary kiln reactor. In an example the material comprises a powder.

In another aspect a carbon nanotube (CNT) hybrid material includes a catalyst supported on alumina and CNTs grown at the catalyst sites on the alumina, wherein the CNTs have an L/D aspect ratio of over about 1000, or over about 400, or over about 700.

Some examples include one of the above and/or below features, or any combination thereof. In an example prior to CNTs growth the alumina comprises agglomerations of elementary alumina particles that are smaller than about 1 micron in size. In an example the CNTs cause de-agglomeration of the elementary alumina particles in the CNT hybrid material. In an example the catalyst comprises transition metals. In an example the nano-alumina particles are less than 70 microns in diameter. In an example the catalyst active metal loading on the alumina is less than 1% by weight. In an example the CNTs are grown on the alumina particles in a rotary kiln reactor.

Some examples include one of the above and/or below features, or any combination thereof. In an example the supported catalyst is fed into the reactor wherein CNTs are grown on the supported catalyst to create a hybrid material, and then the hybrid material is blended with the cementitious or other material. In an example the hybrid material is blended with the cementitious or other material by mechanical mixing of the two in powder form. In an example the hybrid material is blended with the cementitious or other material by preparing a dispersion of the hybrid material in an aqueous solution and then mixing the dispersion with the cementitious or other material. In an example the material comprises a powder.

Some examples include one of the above and/or below features, or any combination thereof. In an example the material further comprises carbon black. In an example carbon black is mixed with the supported catalyst before the CNT is grown. In an example carbon black is present at levels of from about 10% to about 50% by weight of the supported catalyst. In an example the material comprises an aqueous dispersion of the hybrid material with carbon black. In an example the aqueous dispersion is mixed with a cementitious or other material.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 illustrates a rotary kiln catalytic reactor for the continuous production of CNT-Al₂O₃ hybrid material.

FIG. 2 illustrates variation of the mechanical properties as a function of the curing age for Sample 2.

FIGS. 3A-3C include TGA analyses of Portland cement before and after reaction, and Sample 1, respectively.

FIG. 4 includes SEM Images taken at low (25 K×) and high (100 K×) magnifications corresponding to Samples 1 and 2, with the Sample 1 images in the top row and Sample 2 images in the bottom row.

FIG. 5 is a cartoon representation of CNT-Al₂O₃ nanohybrid material and Portland cement with the CNT-Al₂O₃ nano-hybrid.

FIGS. 6A-6C include SEM images of CNTs/CF grown on fly ash particles.

FIG. 7 includes TGA analysis of CNT/CF grow on fly ash particles.

FIG. 8 illustrates variation of mechanical properties as a function of the curing age for Sample 4.

FIG. 9 illustrates conductivity properties of different CNT-Al₂O₃-cement samples.

FIGS. 10A and 10B illustrate piezo-resistivity response properties corresponding to Samples 4 and 5, respectively.

FIGS. 11A and 11B include SEM images taken at 10 K× and 50 K× magnification, respectively, showing MWCNT having high aspect ratio.

FIG. 12 illustrates conductivity properties of CNT-Al₂O₃-cement samples prepared using different mixing methods and CNT composition.

FIGS. 13A and 13B illustrate piezo-resistivity response of CNT-Al₂O₃-cement samples prepared using different mixing methods and CNT composition.

FIG. 14 illustrates piezo-resistivity response of a CNT-Al₂O₃-Carbon Black cement sample.

FIG. 15 illustrates piezo-resistivity response of a 60 wt. % CNT-Al₂O₃-cement hybrid material.

FIGS. 16A-16C includes SEM images taken at 5 K×, 10 K× and 25 K× magnifications, respectively, of several different CNT-Al₂O₃ hybrid materials.

### DETAILED DESCRIPTION

Examples of the systems, methods and apparatuses discussed herein are not limited in application to the details of construction and the arrangement of components set forth in the following description or illustrated in the accompanying drawings. The systems, methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the computer program products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

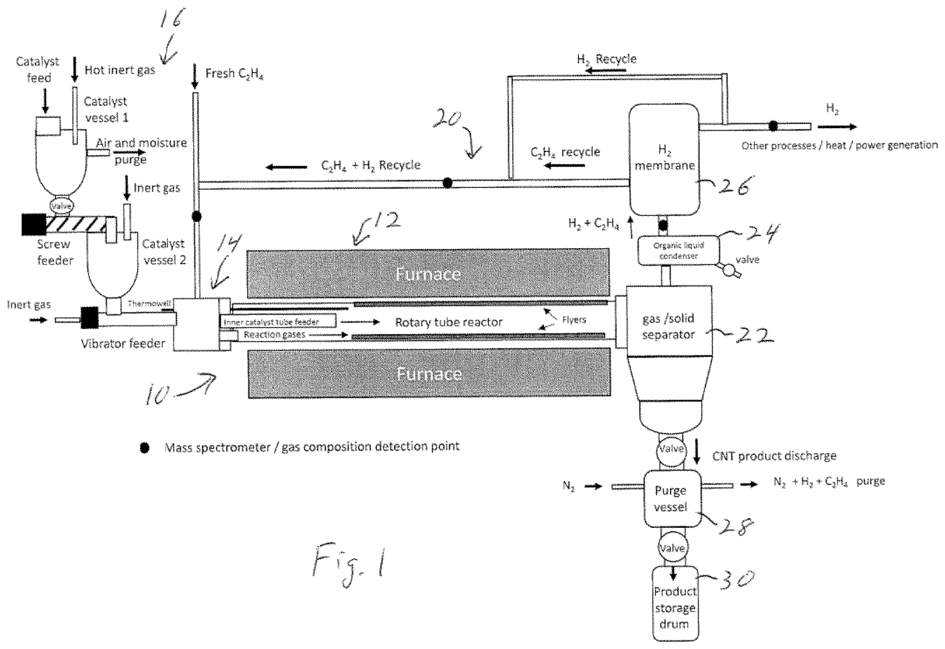

FIG. 1 is a schematic representation of an exemplary rotary tube reactor system 10 that is configured to be used to accomplish hybrid material production processes of the present disclosure. The following description illustrates certain aspects of the disclosure but is not limiting of the scope of the disclosure.

A catalyst feed system 16 can operate as follows. Catalyst particles in powder form are fed into the catalyst supply accumulation vessel 1. The air is subsequently removed from the catalyst supply accumulation vessel 1 using a flow of an inert gas. The inert gas can be preheated at temperatures between 60-150° C. to remove moisture from the catalyst during the purging process. The catalyst particles are then transferred to the second catalyst supply accumulation vessel 2 through a screw feeder. This equipment controls the amount of catalyst fed to the reactor 12. The catalyst and reaction gas feed system 14 can operate as follows. The catalyst particles contained in the second catalyst supply accumulation vessel are fed to the rotary tube reactor through a metal tube coupled to a vibrating catalyst particle feed system. The supply system is maintained in an inert gas atmosphere to inhibit unwanted reactions. When other material(s) are added along with the catalyst in order to produce CNT hybrid materials, these other material(s) can be fed together with the catalyst, or there can be a separate, parallel feed system for the other material(s). The second feed system (not shown) can be the same as the catalyst feed system, or otherwise configured to bring these material(s) to reaction temperature before they are fed into the reactor. In some examples the catalyst and other material(s) are pre-blended before being fed together into the reactor in the manner described above for the catalyst feed.

The tube that feeds catalyst/other materials into the reactor is long enough such that its end is located inside the rotary tube in the preheating zone of the furnace. In some examples the length of the inner tube is approximately ⅓ to ⅙ of the length of the rotary tube in the hot (reaction) zone of the furnace. In some examples the diameter of the inner tube is between ⅓ to ½ the diameter of the rotary tube. In some examples there are multiple heating zones of the reactor. In some examples the reactor is heated by gas or by electricity.

This arrangement results in the catalyst particles reaching the desired reaction temperature before coming into contact with the reaction gases. The inner tube is made of a special corrosion resistant steel, such as Inconel, titanium, etc. The length and diameter of the inner tube relative to the rotary tube is selected to ensure efficient heat transfer during the catalytic process.

The temperature of the process gas and the catalyst particles in the place where they enter in intimate contact is measured through a thermocouple introduced into a thermowell located in the inlet block of the reactor, indicated by a solid black line. Depending on the type of material to be synthesized, flyers or other mass-distribution structures (indicated schematically in FIG. 1) can be placed in the rotating tube to improve the transfer of mass and heat between the solid particles and the reaction gas. Flyers can also improve material flow within the rotating tube. The residence time of the catalyst within the reactor is controlled through the tube rotation speed and its inclination angle.

The product obtained is separated from the gas at the outlet of the reactor, for example using gas/solid separator 22. A system of valves discharges the product into containers (e.g., purge vessel 28) that have an inert gas injection to remove ethylene and hydrogen and cool the material before being packaged (e.g., in storage drum 30).

Liquid condenser 24 is used to remove undesired reaction by-products before hydrogen separation and recycling of reaction gases.

Unreacted ethylene (or other carbon-source reaction gas) and hydrogen are subsequently separated using a H₂ membrane separator 26 that may comprise: organic polymers, nano-porous inorganic materials (ceramic, oxides, porous vycor glass, etc.), dense metal (Pd, and metal alloys), carbon and carbon-nanotubes based membranes, etc.

Unreacted carbon source is then recycled by recycle system 20, and the hydrogen can be used for other catalytic industrial processes, or for other purposes such as for power or heat generation or for transportation. The recycled gas can contain ethylene and hydrogen which facilitates the production reaction of carbon nanotubes and hybrid materials through improved heat transfer and catalyst activation. The amount of fresh ethylene to be fed to the reactor will depend on the level of ethylene conversion in the production of carbon nanotubes/hybrid materials.

The gas composition can be detected at several points as indicated in FIG. 1, using a mass spectrometer or other instrument. The composition data can be used for process control and for other purposes, such as for recording gas composition and quality. A controller (not shown in FIG. 1) is input with the gas composition data (and other variables) and controls valves, heaters, particle feeders and other process equipment (not all shown in FIG. 1) that is used to maintain desired process conditions.

Other details of the reactor and its uses are disclosed in U.S. patent application Ser. No. 17/954,899 filed on Sep. 28, 2022, the entire disclosure of which is incorporated herein by reference, for all purposes.

The following detailed description of examples illustrates but does not limit the scope of the present disclosure.

### Example 1: Preparation of CNT-Cement Hybrid Materials

In this example, two CNT-Al₂O₃ hybrid materials were prepared as follows:

For the first material (Sample 1), fine powders of a MWCNT catalyst based on CoMoFe/MgO—Al₂O₃ (the catalyst is described in U.S. Pat. No. 9,855,551) were mechanically blended with Portland cement in a composition ratio of 20/80 wt. %, respectively, and then CNT synthesis was carried out on the blend in a rotary tube reactor at 600° C., in the presence of a flow of 80% V ethylene in hydrogen for 10-minute reaction time. The second material (Sample 2) was prepared by mechanically blending Portland cement powder with a previously-synthesized hybrid MWCNT-Al₂O₃ material, in a composition ratio of 20/80 wt. %, respectively. The compositions of both CNT-Al₂O₃-cement materials are shown in Table 2. In both cases, the alumina content is practically the same while the MWCNT content was 5 wt. % for sample 1 and 3 wt. % for sample 2. Mechanical performance test results are set forth in Table 3.

TABLE 2
Composition of the CNT-Al₂O₃-cement samples.

| | MWCNT | Cement | Alumina |
|---|---|---|---|
| | content (wt. %) | content (wt. %) | content (wt. %) |
| Sample 1 | 5.0 | 76.0 | 19.0 |
| Sample 2 | 3.0 | 77.6 | 19.4 |

TABLE 3
Mechanical performance test of the CNT-Al₂O₃-cement samples

| | Flexural Strength (MPa) | | |
|---|---|---|---|
| | Curing age (days) | | |
| | 3 | 7 | 28 |
| Mortar-reference | 4.32 | 5.29 | 5.91 |
| Sample 1 | 5.14 | 6.53 | 9.02 |
| Sample 2 | 5.85 | 7.38 | 9.76 |

| | Modulus of Elasticity (GPa) | | |
|---|---|---|---|
| | Curing age (days) | | |
| | 3 | 7 | 28 |
| Mortar-reference | 9.77 | 11.16 | 14.29 |
| Sample 1 | 10.42 | 13.37 | 17.96 |
| Sample 2 | 12.74 | 15.47 | 20.76 |

| | Compressive Strength (MPa) | | |
|---|---|---|---|
| | Curing age (days) | | |
| | 3 | 7 | 28 |
| Mortar-reference | 20.05 | 25.87 | 31.31 |
| Sample 1 | 25.27 | 28.74 | 35.86 |
| Sample 2 | 27.04 | 30.76 | 37.62 |

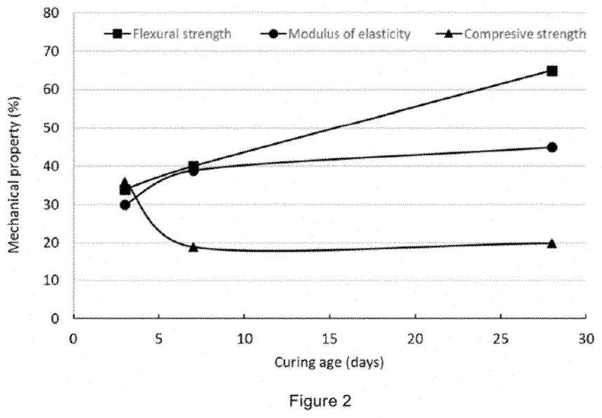

FIG. 2 illustrates variation of mechanical properties as a function of the curing age for Sample 2. Both flexural strength and modulus of elasticity increase progressively with the curing age, while the compressive strength decreases during the first 7 days and then remains constant. Sample 2 delivers +65%, 45% and 20% higher flexural, modulus of elasticity and compressive strength than a cement mortar reference after 28 days curing age. The observed values for Sample 1 were 53%, 24% and 15%, respectively.

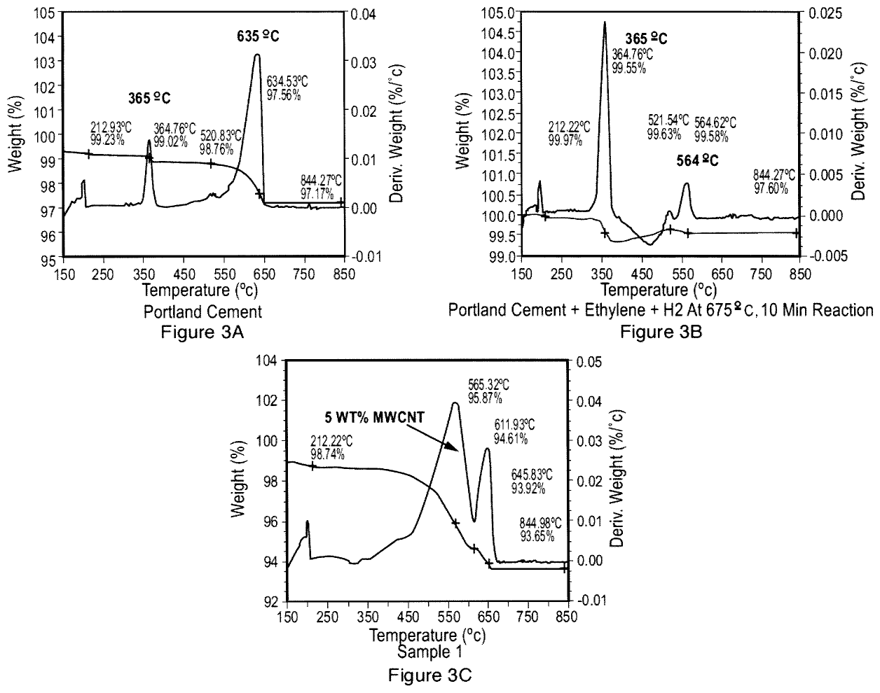

FIGS. 3A and 3B show results of the thermogravimetric analysis (TGA) of Portland cement before and after being processed under reaction conditions in the presence of the ethylene+H₂ gas mixture at 675° C. for 10 minutes residence time. As can be seen, important structural and composition changes of the cement occur after the reaction. These structural changes can significantly influence the mechanical, electrical and thermal conductivity properties of the concrete. This would explain the results obtained with Sample 1, where although the MWCNT content is higher than in Sample 2, the improvement in the mechanical properties of the cementitious material was inferior. FIG. 3C shows the TGA analysis of Sample 1 where a signal at 565° C. can be attributed to MWCNT.

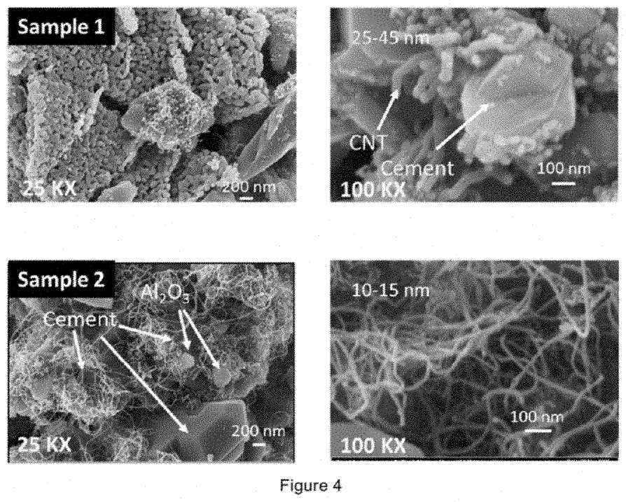

FIG. 4 includes four SEM Images taken at low (25 K×) and high (100 K×) magnifications corresponding to Samples 1 and 2, with the Sample 1 images in the top row and Sample 2 images in the bottom row. The formation of short MWCNTs (<200 nm) and diameter approximately between 25 and 45 nm can be clearly seen in Sample 1. Some cement particles are observed that are not in contact with the nanotubes. On the contrary, in Sample 2, a mesh of long MWCNTs with a diameter between 10 and 15 nm can be seen surrounding and filling the spaces between the cement particles.

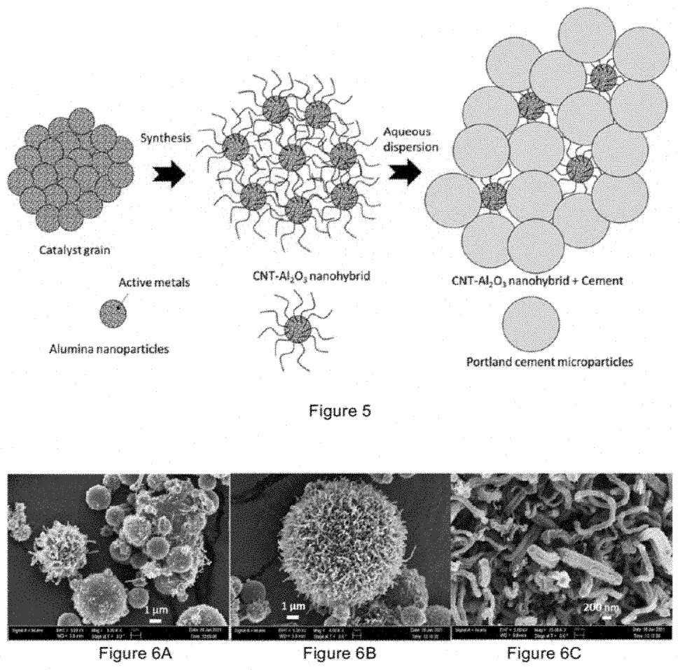

FIG. 5 is a simplified representation of the creation of the CNT-Al₂O₃ hybrid material, and the Portland cement additive with CNT-Al₂O₃ nanoparticles hybrid material. The catalyst contains primary or elementary nano-alumina particles, smaller than about 1 micron in size, which are typically agglomerated to form grains of sizes<100 microns. During the catalyst preparation, the active metals are deposited inside the pores as well as on their external surface of the elementary particles. During synthesis, the active metals catalyze the decomposition reaction of the carbon source into CNT+H₂. CNTs growth in all directions causes de-agglomeration of elementary alumina particles. The hybrid CNT-Al₂O₃ material is formed. The integration of the CNT-Al₂O₃ nanohybrid in Portland cement is achieved through the deagglomeration of the nanohybrid particles during the aqueous dispersion preparation.

The same concept applies for other types of catalysts. For example, silica fumes are composed of elemental SiO₂ particles of nanometric size. It has been observed that an addition of 10% nano-SiO₂ with dispersing agents resulted in a 26% increase in compressive strength after 28 days of curing. The composite addition of nano-SiO₂, and high volume of fly ash, and silica fume was found to be a very effective way to achieve good mechanical performance and an economic way to use both additives.

### Example 2: Growth of CNTS on Fly Ash Particles

FIGS. 6A-6C are SEM images corresponding to the synthesis of CNTs and CFs on fly ash particles. Fly ash is a coal combustion product that is composed of fine particles of mainly metal oxides that are driven out of coal-fired boilers together with the flue gases. SiO₂ (both amorphous and crystalline forms), Al₂O₃, Fe₂O₃ and CaO are the main chemical components present in fly ashes. Fly ash can replace some or most of the Portland cement in concrete production, leading to higher porosity at early age, and increases in mechanical strength, chemical resistance and durability.

The CNT synthesis was carried out in a rotary tube reactor at 650° C., in the presence of a flow of 80% V ethylene in hydrogen for 10-minute reaction time. The iron oxide particles contained in the fly ash act as a catalyst.

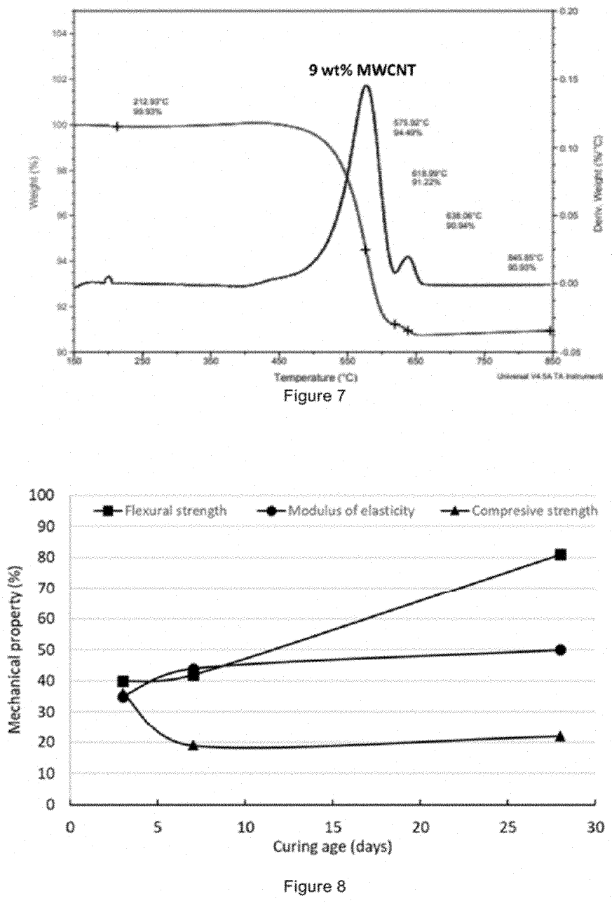

As can be seen in FIG. 6A, not all the particles show growth of CNT/CFs. A fly ash particle with CNT/CF is clearly shown in FIG. 6B. The image taken at highest magnification (FIG. 6C, 25 K×) shows the formation of braids of CNTs and CFs with lengths of approximately 1-1.5 microns and few hundred nm in diameter on the surfaces of the fly ash particles. The CNTs/CFs content on the fly ash particles, as determined by TGA analysis, is about 9 wt. % (FIG. 7).

### Example 3: Influence of the CNT Aspect Ratio on Mechanical and Electrical Properties and Piezoelectric Response

In this example, three CNT-Al₂O₃ hybrid materials (samples 3, 4, and 5) were synthesized having differences in CNT content (15, 20, and 25 wt. % by weight of alumina as set forth in Table 4 below) by following the procedure described in example 1. The amount of carbon deposited on the Al₂O₃ nanoparticles depends on the reaction time, which varied between 3 and 10 minutes.

The CNT-Al₂O₃ hybrid materials powders were mechanically blended with Portland cement in such proportions that the MWCNT content in the samples were the same (0.15 wt. %). Table 4 shows the weight composition and aspect ratio properties of each sample. As the carbon yield increases, the length of the tubes progressively increases but their diameter remains unchanged (10+/−3 nm). Consequently, the CNT aspect ratio increases as a function of the increase in carbon yield during the synthesis of the CNT-Al₂O₃ hybrid material.

TABLE 4
Properties of Samples 3, 4 and 5.

| | MWCNT | MWCNT | CNT | Alumina |
|---|---|---|---|---|
| | content | content | diameter | content |
| | in CNT-Al₂O₃ | in cement | aspect ratio | in cement |
| | (wt. %) | (wt. %) | (L/D) | (wt. %) |
| Sample 3 | 15 | 0.15 | 435 | 0.85 |
| Sample 4 | 20 | 0.15 | 570 | 0.60 |
| Sample 5 | 25 | 0.15 | 730 | 0.45 |

Mechanical performance tests (flexural, modulus of elasticity and compressive strength) were performed for samples 3, 4 and 5. The results are shown in Table 5. As the aspect ratio (L/D) increases, the mechanical properties of the cement improve significantly.

FIG. 8 shows the variation of the mechanical properties as a function of the curing age for Sample 4.

As the curing age increases, the percentage increase in flexural properties and the modulus of elasticity becomes greater with respect to the mortar reference. In the case of compressive strength, the percentage tends to decrease from 36% to 19% during the first 7 days and then tends to stabilize. After 28 hours of curing age, flexural strength, the modulus of elasticity and the compressive strength values were 81%, 50% and 22%, respectively. These results represent an improvement of the flexural strength and modulus of elasticity properties with respect to the samples prepared in example 1, whose MWCNT content in the cement was 5 and 3 wt. % for samples 1 and 2, vs 0.15 wt. % for samples 3 and 4, respectively.

TABLE 5
Mechanical performance test of the
CNT-Al₂O₃-cement prepared samples

| | Flexural Strength (MPa) | | |
|---|---|---|---|
| | Curing age (days) | | |
| | 3 | 7 | 28 |
| Mortar-reference | 4.32 | 5.29 | 5.91 |
| Sample 3 | 6.06 | 7.56 | 10.13 |
| Sample 4 | 6.19 | 7.75 | 10.31 |
| Sample 5 | 6.44 | 7.88 | 10.56 |

| | Modulus of Elasticity (GPa) | | |
|---|---|---|---|
| | Curing age (days) | | |
| | 3 | 7 | 28 |
| Mortar-reference | 9.23 | 11.15 | 14.30 |
| Sample 3 | 12.50 | 14.72 | 19.72 |
| Sample 4 | 12.57 | 15.00 | 19.72 |
| Sample 5 | 12.78 | 15.28 | 20.00 |

| | Compressive Strength (MPa) | | |
|---|---|---|---|
| | Curing age (days) | | |
| | 3 | 7 | 28 |
| Mortar-reference | 20.05 | 25.87 | 31.31 |
| Sample 3 | 27.03 | 30.47 | 37.50 |
| Sample 4 | 27.19 | 30.63 | 37.81 |
| Sample 5 | 27.34 | 30.94 | 37.97 |

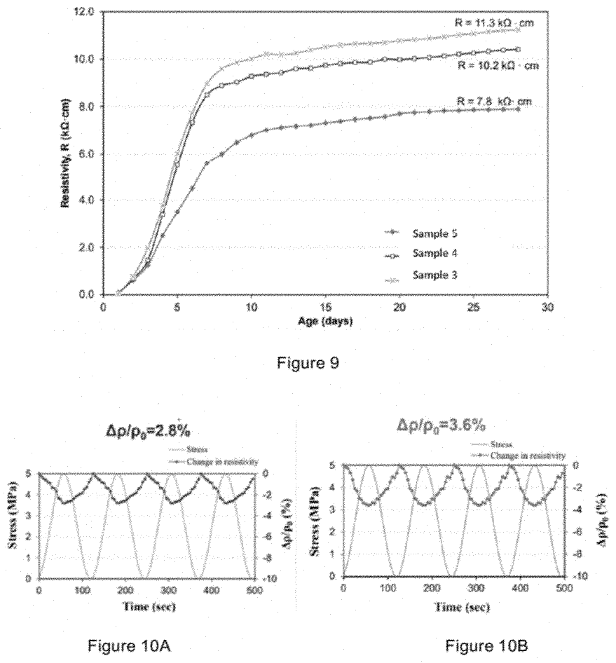

Electrical conductivity properties at different curing ages corresponding to samples 3, 4 and 5 are shown in FIG. 9. The most conductive material was Sample 5 which has the highest CNT aspect ratio (730).

Piezo-resistivity response test results corresponding to the samples 4 and 5 are shown in FIGS. 10A and 10B, respectively. Sample 5 shows the greatest changes in resistivity (Δρ/ρₒ) when the sample was submitted to different stress level.

### Example 4: Influence of the CNT-Al₂O₃-Cement Preparation Method

In this example, a MWCNT-Al₂O₃ hybrid material having 35 wt. % MWCNT and L/D>1000 was employed. FIGS. 11A and 11B are SEM images taken at different magnifications (10 K× and 50 K×, respectively) of the MWCNT-Al₂O₃ hybrid material. Long MWCNTs of more than 10 microns in length, and alumina nanoparticles of approximately 500 nm in diameter can be observed.

An aqueous suspension was prepared by mixing using 350 ml H₂O, 0.10 or 0.15 wt. % MWCNT-Al₂O₃ hybrid material in cement and 0.4% superplasticizer of cement. The dispersions were prepared by using ultrasonication or intensive mixer equipment. In the intensive mixer, the MWCNT-Al₂O₃ hybrid material in dry form, and the mixing water was placed in the bowl and mixed for 10 minutes using a speed of 285 rpm. The dry materials (cement and sand) were added in the mix for the preparation of mortar specimens.

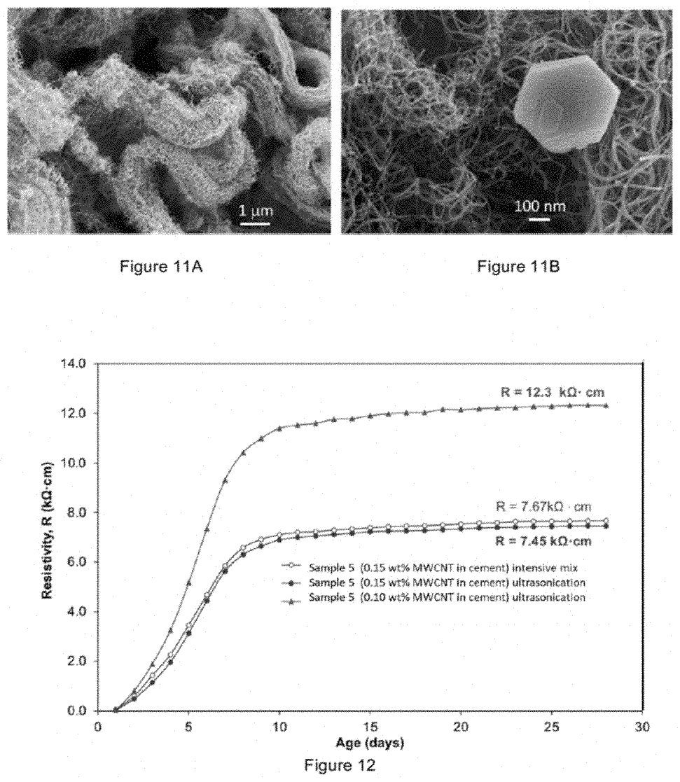

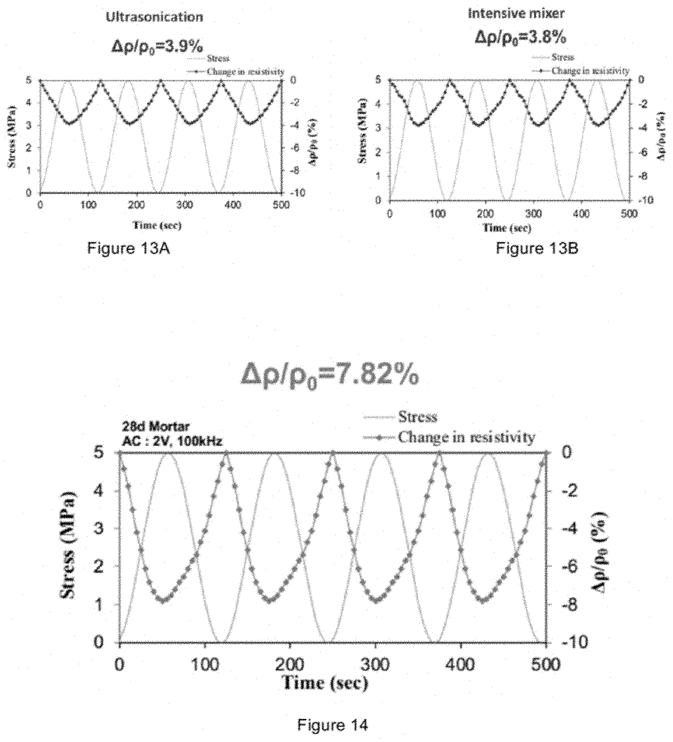

FIG. 12 shows the variation of the electrical conductivity of the samples prepared according to different mixing techniques and CNT content in the cement as a function of curing age. By increasing the CNT content in the cement from 0.10 to 0.15 wt. %, the resistivity of the material decreases by about 39%. For the samples containing 0.15% CNT in the cement, no significant differences in electrical conductivity are observed when using ultrasonication or intensive mixer equipment. No significant differences are observed in piezoelectric response between the samples prepared using different mixing equipment. See FIGS. 13A and 13B (ultrasonication and intensive mixing, respectively). These results clearly demonstrate that the CNT-Al₂O₃ material can be easily dispersed using conventional mixing equipment.

### Example 5: CNT-Al₂O₃-Carbon Black Hybrid Material for Smart Concrete

As mentioned above, carbon black (CB) has been used as an additive to enhance the electrical conductivity properties and piezoelectric response in the manufacture of smart concrete. In this example (Sample 6), catalyst powder was mixed with carbon black in a certain proportion (40% by weight of catalyst) and the CNT synthesis was carried in a rotary tube reactor under the reaction conditions described in example 1. Subsequently, an aqueous dispersion was prepared with the hybrid material CNT-Al₂O₃—CB and then mixed with the cement powder following the same procedure used in example 4.

Table 6 shows the composition by weight of the hybrid material CNT-Al₂O₃—CB and in the cement mixture. The total conductive carbon composition is 0.13 wt. % (MWCNT=0.08 wt. % and CB: 0.05 wt. %) which is comparable with the MWCNT content in samples 3 to 5 (cement). Note that the composition of MWCNT is lower than samples 3 to 5.

TABLE 6
Composition of Sample 6 of cement

| | MWCNT-Al₂O₃- | | | |
|---|---|---|---|---|
| | Carbon | MWCNT in | CB in | Nano-Al₂O₃ |
| | Black in cement | cement | cement | in cement |
| | (wt. %) | (wt. %) | (wt. %) | (wt. %) |
| Sample 6 | 0.15 | 0.08 | 0.05 | 0.02 |

TABLE 7
Electrical conductivity and mechanical properties of Sample 6.

| Curing age (days) | 3 | 7 | 28 |
|---|---|---|---|
| Resistivity (K · Ω · cm) | 1.6 | 4.5 | 6.8 |
| Flexural Strength (MPa) | 5.7 | 7.1 | 10.3 |
| Young Modulus (GPa) | 12.0 | 14.6 | 22.1 |
| Compressive strength (MPa) | 21.1 | 25.8 | 32.7 |
| Flexural Strength (%) | 32% | 34% | 74% |
| Young Modulus (%) | 30% | 31% | 55% |
| Compressive strength (%) | 5% | 0% | 4% |

Table 7 shows the electrical and mechanical conductivity properties of the Sample 6 hybrid material (CNT-Al₂O₃-Carbon Black) in the cement as a function of curing time. An improvement in the conductive properties of cement is observed when compared with the results obtained for Sample 5. The Piezoelectric response of sample 6 (FIG. 14) also increased significantly (from 3.9% to 7.82%).

Table 7 also lists improvements in mechanical properties (in %) as compared to a mortar reference. Flexural strength and modulus of elasticity properties also improved significantly by approximately 74% and 55%, respectively, with respect to the mortar reference after 28 days of curing time. The compressive strength increased 4%.

### Example 6

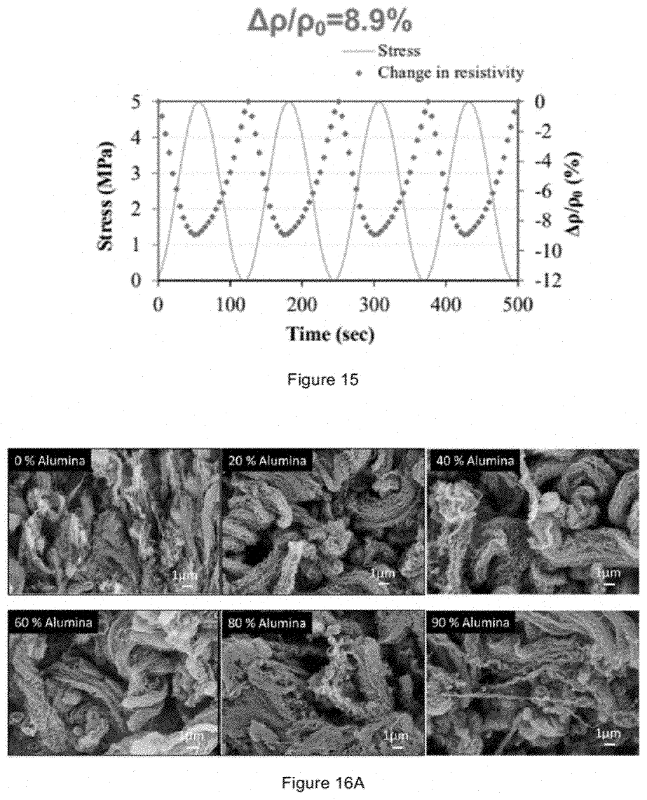

In this example, a MWCNT-Al₂O₃ hybrid material having 60 wt. % MWCNT was prepared and a series of experiments were conducted by combining Portland cement with the CNT hybrid material and 30 wt. % fly ash. Table 8 includes changes in the mechanical properties of the different prepared samples obtained after 28 days curing age (as compared to the Portland cement reference). Table 8 also lists improvements in mechanical properties (in %) as compared to a mortar reference. The mechanical strength properties slightly increased after adding 30% of fly ash to the mortar. When 0.1 wt. % of CNT-Al₂O₃ hybrid material was added to the mortar, flexural strength, the modulus of elasticity and the compressive strength increased by about 88%, 82% and 11%, respectively. This material also showed the highest piezoelectric response value (FIG. 15). The addition of 30 wt. % fly ash and 0.1 wt. % CNT-Al₂O₃ hybrid material to the mortar caused an improvement of about 11% in the compressive strength property while, the flexural strength and the elasticity modulus values increased by about 28% and 25%, respectively.

TABLE 8
Mechanical performance test of the CNT-
Al₂O₃-Fly cement prepared samples

| | Compressive | Flexural | Elasticity |
|---|---|---|---|
| | Strength (MPa) | Strength (MPa) | Modulus (GPa) |
| Mortar | 31.31 | 5.91 | 14.30 |
| Mortar + Fly Ash | 34.64 | 6.26 | 14.77 |
| Mortar + CNT-hybrid | 34.19 | 11.1 | 26.06 |
| Mortar + CNT- | 34.85 | 7.59 | 17.86 |
| hybrid + Fly Ash | | | |
| Mortar + Fly Ash | 9% | 6% | 3% |
| Mortar + CNT-hybrid | 11% | 88% | 82% |
| Mortar + CNT- | 11.% | 28% | 25% |
| hybrid + Fly Ash | | | |

Comparing the results obtained when using MWCNT-Al₂O₃—CB (Example 5) vs CNT-Al₂O₃(Example 6) it can be clearly seen that the CNT-Al₂O₃ delivers superior performance benefits in mechanical reinforcement, electrical conductivity and piezoelectric properties, despite the difference in total carbon content in cement (0.13% in MWCNT-Al₂O₃—CB vs 0.08 wt. % in the CNT-Al₂O₃ hybrid material).

### Example 7

In this example, CNT-Al₂O₃ hybrid materials having different CNT compositions were synthesized by mechanically blending fine alumina powder with fine CoMoFe/MgO-Al₂O₃ catalyst powder employed in Example 1. The composition of the alumina powder in the blends varied from 0 to 95 wt. %. The particle size of both materials, as determined through the laser scattering technique, varied between 1 to 10 microns in diameter (Mean=3 to 4μ). The CNT synthesis was carried out in a rotary tube reactor at 650° C. temperature, in the presence of a gas flow that comprise 80% V ethylene and 20% V hydrogen for 10-minutes reaction time.

Table 9 shows the results of the synthesis of CNT-Al₂O₃ hybrid materials obtained from different catalyst-alumina blends. The results clearly show that by diluting the catalyst particles by 20% with alumina powder, the CNT yield remains above 80 wt. %. Increasing the alumina composition in the blend, the CNT yield tends to decrease progressively until reaching a CNT composition in the hybrid material of 27% for 95% Al₂O₃ and 5 wt. % catalyst blends.

TABLE 9
Composition of the CNT-Al₂O₃ hybrid material obtained
with different catalyst-alumina blends.

| Catalyst (wt. %) | Alumina (wt. %) | MWCNT (wt. %) |
|---|---|---|
| 100 | 0 | 84.0 |
| 80 | 20 | 81.2 |
| 60 | 40 | 77.9 |
| 40 | 60 | 71.8 |
| 20 | 80 | 56.2 |
| 10 | 90 | 40.5 |
| 5 | 95 | 27.0 |

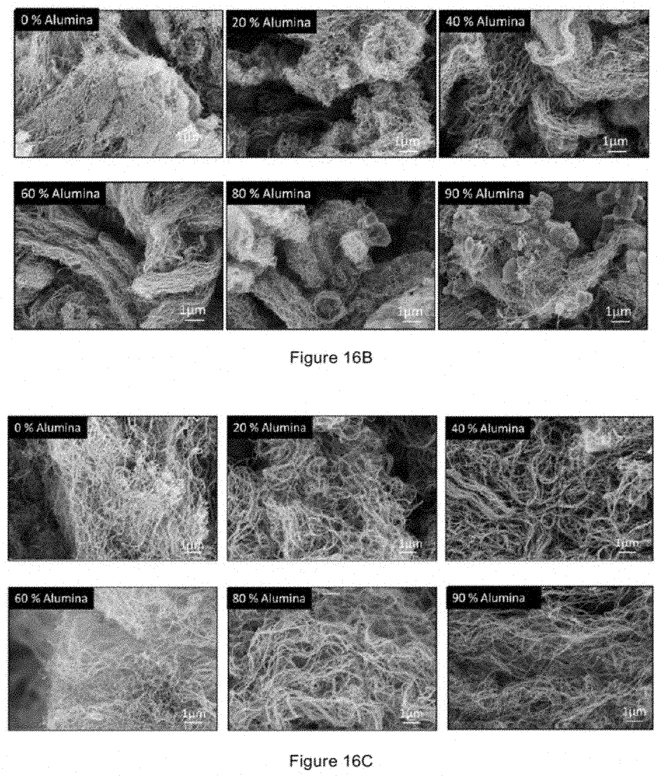

SEM Images taken at different (5K, 10K and 25 K) magnifications of the CNT-Al₂O₃ hybrid materials of Table 9 are shown in FIGS. 16A to 16C, respectively, for alumina composition in the blend between 0% to 90 wt. % (0%, 20%, 40%, 60%, 80%, and 90%). When no alumina is blended with the catalyst particles, the formation of a compact mesh is observed where the CNTs are found highly entangled. When alumina powder is progressively blended with the catalyst particles, the formation of CNTs structures in rods-shapes are observed. These CNT rods are separated from each other when the alumina content in the blend increases. The CNTs become longer while their diameter remains unchanged for all the samples analyzed (8-13 nm). Alumina and catalyst particles having sizes of approximately 0.5 to 2 microns were observed in greater proportion for samples that contain greater than 80 wt. % alumina. FIG. 16C shows clear evidence of the formation of an open mesh of CNTs when the alumina content in the blend is greater than 20 wt. %. These tubes are easier to disentangle and would require less energy to disperse. Compared to prior art, this material can be easily integrated into the cement particles in suspension, powder, or granulated forms.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A carbon nanotube (CNT) hybrid material, comprising:
a blend comprising a catalyst supported on at least one of a metal, metalloid, metal oxide or carbon support, and at least one material selected from the group of materials consisting of: cementitious materials, materials used in the production of cementitious materials, and materials used to enhance cementitious materials; and
CNT on the blend.

2. The material of claim 1, wherein the cementitious material comprises a hydraulic cement.

3. The material of claim 2, wherein the hydraulic cement comprises Portland cement.

4. The material of claim 1, wherein the cementitious material comprises a supplementary cementitious material (SCM).

5. The material of claim 4, wherein the SCM comprises fly ash.

6. The material of claim 1, wherein the catalyst is supported on nano-alumina particles.

7. The material of claim 1, wherein the CNT are grown on at least part of the blend in a rotary kiln reactor.

8. The material of claim 7, wherein the supported catalyst and the cementitious material are blended and then fed into the reactor wherein CNT are grown on this blend.

9. The material of claim 7, wherein the supported catalyst is fed into the reactor wherein CNT is grown on the supported catalyst to create a hybrid material, and then the hybrid material is blended with the cementitious material.

10. The material of claim 9, wherein the hybrid material is blended with the cementitious material by mechanical mixing of the two in powder form.

11. The material of claim 9, wherein the hybrid material is blended with the cementitious material by preparing a dispersion of the hybrid material in an aqueous solution and then mixing the dispersion with the cementitious material.

12. A carbon nanotube (CNT) hybrid material, comprising:
a fly ash material comprising iron oxide and other metal oxides; and
CNT on the fly ash.

13. The material of claim 12, wherein the CNT are grown on the fly ash in a rotary kiln reactor.

14. A carbon nanotube (CNT) hybrid material, comprising:
a catalyst supported on alumina; and
CNT grown at the catalyst sites on the alumina, wherein the CNT have an aspect ratio of over 1000.

15. The material of claim 14, wherein prior to CNT growth the alumina comprises agglomerations of elementary alumina particles that are smaller than about 1 micron in size.

16. The material of claim 15, wherein the CNT cause de-agglomeration of the elementary alumina particles in the CNT hybrid material.

17. The material of claim 14, wherein the nano-alumina particles are less than 70 microns in diameter.

18. The material of claim 14, wherein the catalyst active metal loading on the alumina is less than 1% by weight.

19. The material of claim 14, wherein the CNT are grown on the alumina particles in a rotary kiln reactor.

20. The material of claim 19, wherein the supported catalyst is fed into the reactor wherein CNT is grown on the supported catalyst to create a hybrid material, and then the hybrid material is blended with a second material selected from the group of materials consisting of: cementitious materials, materials used in the production of cementitious materials, and materials used to enhance cementitious materials.

21. The material of claim 20, wherein the hybrid material is blended with the second material by mechanical mixing of the two in powder form.

22. The material of claim 20, wherein the hybrid material is blended with the second material by preparing a dispersion of the hybrid material in an aqueous solution and then mixing the dispersion with the second material.

23. The material of claim 14, further comprising carbon black.

24. The material of claim 23, wherein carbon black is mixed with the supported catalyst before the CNT is grown.

25. The material of claim 24, wherein carbon black is present at levels of from about 10% to about 50% by weight of the supported catalyst.

26. The material of claim 24 comprising an aqueous dispersion of the hybrid material with carbon black.

27. The material of claim 26, wherein the aqueous dispersion is mixed with a cementitious material.
